(19) United States
(12) Patent Application Publication
(10) Pub. No.: US 2009/0077495 A1
(43) Pub. Date: Mar. 19, 2009

(54) Method and System of Creating a Personalized Homepage

(75) Inventors: Tapan Bhat, Mountain View, CA (US); Michail Masouras, San Francisco, CA (US); Parag Jain, Mountain View, CA (US); Prasanna Padmanabhan, Mountain View, CA (US); Shanan Jeremy Delp, San Francisco, CA (US); Joseph Zaki Bou-Younes, San Francisco, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/858,046

(22) Filed: Sep. 19, 2007

(51) Int. Cl. G06F 3/048

(52) U.S. Cl. 715/811

(57) ABSTRACT

A method of automatically creating a personalized homepage which infers one or more categories of interest from previous user activities in a different but related web service product, instead of expressly asking the user to input his/her areas of interest.

### BACKGROUND

1. Field of the Invention

The present invention relates generally to the internet, and more particularly to a method and system of automatically creating a personalized homepage for a user without requiring the user to input his/her areas of interest.

2. Description of Related Art

Properties on a web site are usually indexed by categories they belong to. The web site may have a directory of categories, and a category and/or sub-category may be assigned to each property. When a user is interested in a category, he/she may select that category and properties belonging to that category may be shown on a web page.

Existing methods for setting up personalized homepages require users to input categories they are interested in. A web site may provide to a user, e.g., John, a directory of categories, and may ask him to select one or more categories (or areas) which he is interested in and wants to have on his personalized homepage. As shown in FIG. 1A, the categories may include, e.g., News, Weather, Stock Market Information, TV, and Movies. A category may include a number of first level sub-categories. For example, the category News may include sub-categories such as Top Stories, Local, World, Entertainment, Science/Technology, Business, Sports, and Health. A first level sub-category may include a number of second level sub-categories, e.g., the first level sub-category Sports may include sports such as Football, Baseball, Basketball, Golf, Tennis, and Soccer.

The user John may have to look at these categories and sub-categories one by one, think about whether he may be interested in any of them and select those he is interested in. In one example, John may select categories News, Weather, Stock Market Information, and TV. For the category News, John may select first level sub-categories Top Stories, Local, Sports, and Health. For the first level sub-category Sports, John may select a second level sub-category Basketball. After receiving the selections, a personalized homepage for John may be created.

As shown in FIG. 1B, the personalized homepage for the user John may include contents (or properties) in categories and sub-categories he selected, i.e., categories News, Weather, Stock Market Information and TV; first level sub-categories Top Stories, Local, Sports and Health; and the second level sub-category Basketball. A navigation link may be provided to a piece of news. When the user clicks on a navigation link, the content of the news may be presented, either in a separate browser window or in a separate tab in the browser.

Other homepages may include not just topics or categories of interest, but also elements, called widgets, which a user may select for placement on his/her home page. A user may be provided with a list of categories of widgets (e.g. news, sports, games). When a user selects a category, he/she then may be presented with a list of widgets which the user can select for addition to the home page.

The existing methods are not automatic, and are not very convenient, especially for those who are busy. The user has to do a lot of work to create his/her personalized homepage. Accordingly, a more user friendly method of creating a personalized homepage would be desirable.

### BRIEF DESCRIPTION OF THE DRAWINGS FIGURES

Embodiments of the present invention are described herein with reference to the accompanying drawings, similar reference numbers being used to indicate functionally similar elements.

FIG. 1A illustrates a web page showing a directory of categories according to an existing method of generating a personalized homepage.

FIG. 1B shows an example of a personalized web page.

FIG. 2 illustrates a system for creating a personalized homepage according to an embodiment of the present invention.

FIG. 3 illustrates a flow chart of a method of compiling categories of interest for a user according to one embodiment of the present invention.

FIG. 4 illustrates a database of categories of user interest according to an embodiment of the present invention.

FIG. 5 illustrates a flowchart of a method of creating a personalized homepage according to an embodiment of the present invention.

FIG. 6 illustrates a flowchart of a method of creating a personalized homepage according to an embodiment of the present invention.

FIG. 7 illustrates a flowchart of a method of creating a personalized homepage according to an embodiment of the present invention.

### DETAILED DESCRIPTION

The present invention provides a method of creating personalized homepage which infers one or more categories of user interest from previous user activities in a different but related web service product instead of expressly asking the user to input his/her areas of interest. For example, when a user wants to create a personalized homepage at a web service product my.yahoo.com (My Yahoo!), the related web service products may be: search.yahoo.com, shopping.yahoo.com, groups.yahoo.com or www.yahoo.com. The method of the present invention may automatically create a personalized homepage for the user based on inferred categories of user interest before the user expressly reveals the categories in which he/she is interested, thus saving user time and effort. The invention could be carried out by computer-executable instructions, such as program modules. Advantages of the present invention will become apparent from the following detailed description.

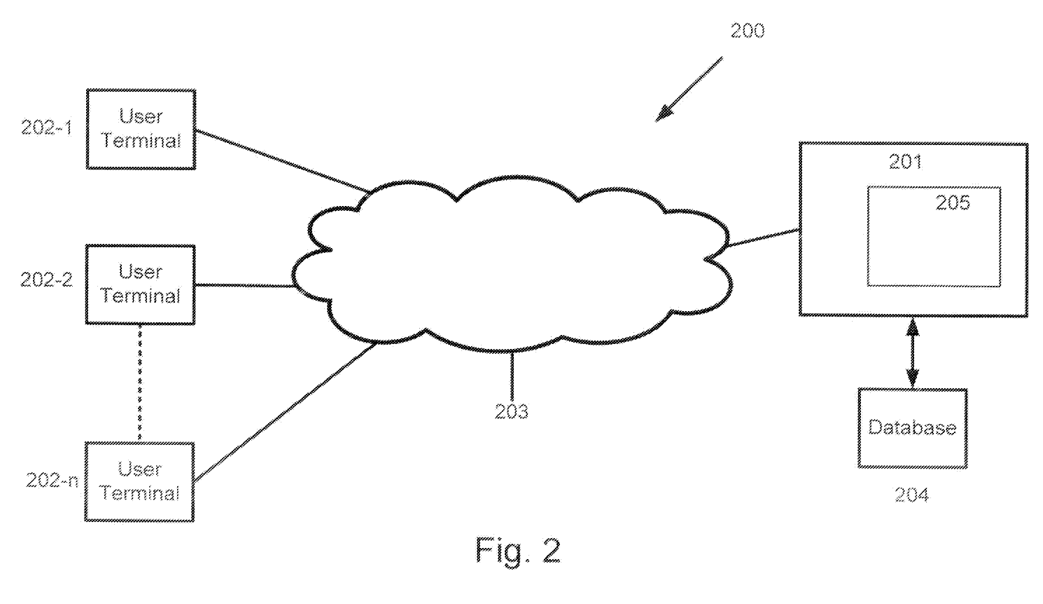

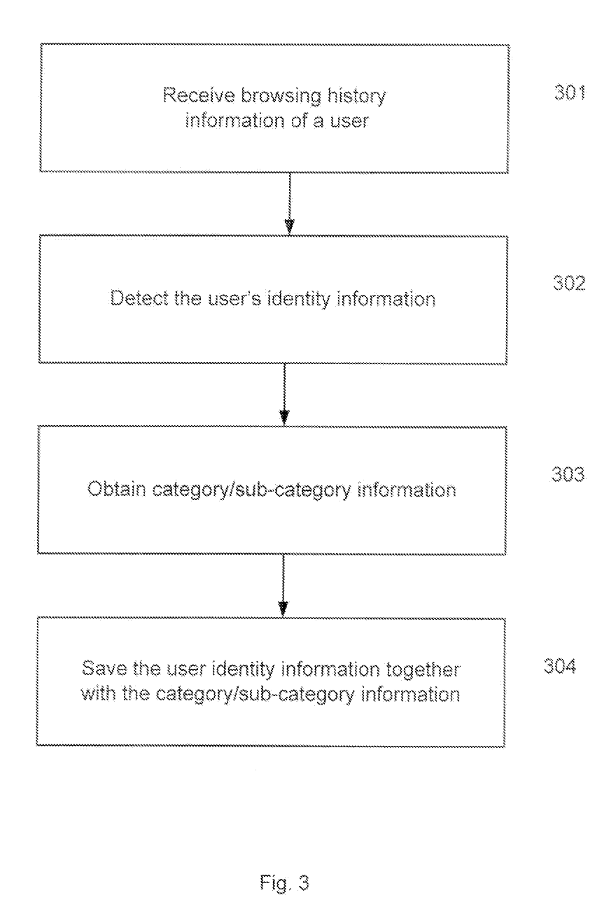

FIG. 2 illustrates a system for creating a personalized homepage according to an embodiment of the present invention. The system 200 may have a server 201, with which a number of user terminals 202-1, 202-2, 202-3 . . . 202-n, not necessarily part of the system 200, may communicate over a network 203. The user terminals 202 may be personal computers, handheld or laptop devices, microprocessor-based systems, set top boxes, or programmable consumer electronics. The server 201 accesses data in a category database 204. The server 201 may be a computer system, which may include one or more of a screen, an input device, a processing unit 205, a system memory, ports for communicating with the network 203, and a system bus coupling various components in the computer system. The processing unit 205 may be configured to execute various methods, including those shown in FIGS. 3, 5, 6, and 7.

FIG. 3 illustrates a flow chart of a method of compiling user categories of interest according to one embodiment of the present invention. At 301, the processing unit 205 may receive browsing history information of a user, e.g., a navigation link clicked by a user. At 302, the unit 205 may detect the user's identity, e.g., John Smith. The user identity information may be obtained from the user's login information or browser cookie. At 303, the unit 205 may obtain the category and sub-category assigned to the property to which the navigation link leads. The category and sub-category may be, e.g., News, Sports, and Basketball. At 304, the unit 205 may save the user identity, category and sub-category as a record to the category database 204, and use “John Smith” as the identifier of the record. If the user John visits additional properties, 301-303 may be repeated, and the categories and sub-categories assigned to those properties may be added to the record “John Smith”. In one embodiment, a user may nave a toolbar as part of his/her browser; the presence of the toolbar makes it possible to communicate a user's browsing habits or activities to the processing unit 205.

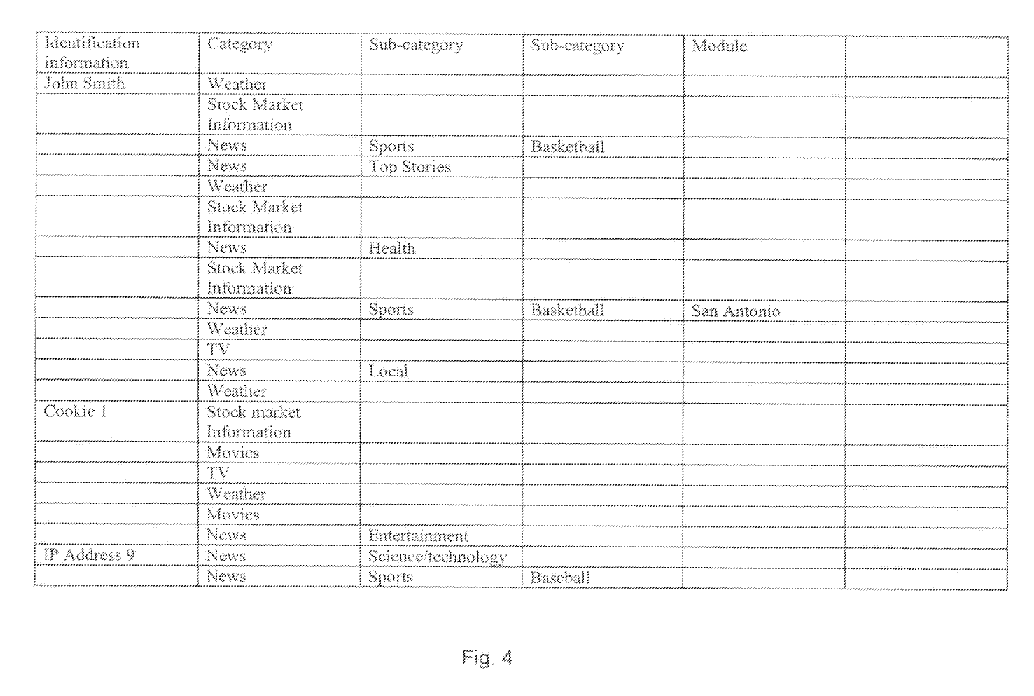

FIG. 4 illustrates a user category database 204 according to one embodiment of the present invention. As shown, for each user, the database stores his/her identify, and category and sub-category of properties he/she has visited. As shown, the database stems browsing history information about 13 visits for the user John Smith, including 5 visits to properties in the category News, 4 visits to properties in the category Weather, 3 visits to properties in the category Stock Market Information, and 1 visit to properties in the category TV.

In one embodiment, the category and sub-category may be set to expire after a certain period of time, e.g., 30 days, so that the data will only indicate the users' current interests.

The data stored in the database 204 are based on the users' experiences outside the web service product providing the personalized homepage service. When a user is trying to set up a personalized homepage, he/she has not had any interaction, or experience, with the web service product providing the personalized homepage service yet. The data in the database 204 may be collected previously during execution of a different but related web service product. In one embodiment, the user wants to set up a personalized homepage at my.yahoo.com, and the browsing history information was collected when the user previously visited properties on www.yahoo.com, conducted searches on search.yahoo.com, browsed products on shopping.yahoo.com or joined a group at groups.yahoo.com. When a user wants to try new services provided by the web service product My Yahoo! and set up a My Yahoo! personalized homepage, previous browsing history on those related web service products may be used to infer areas the user may be interested in.

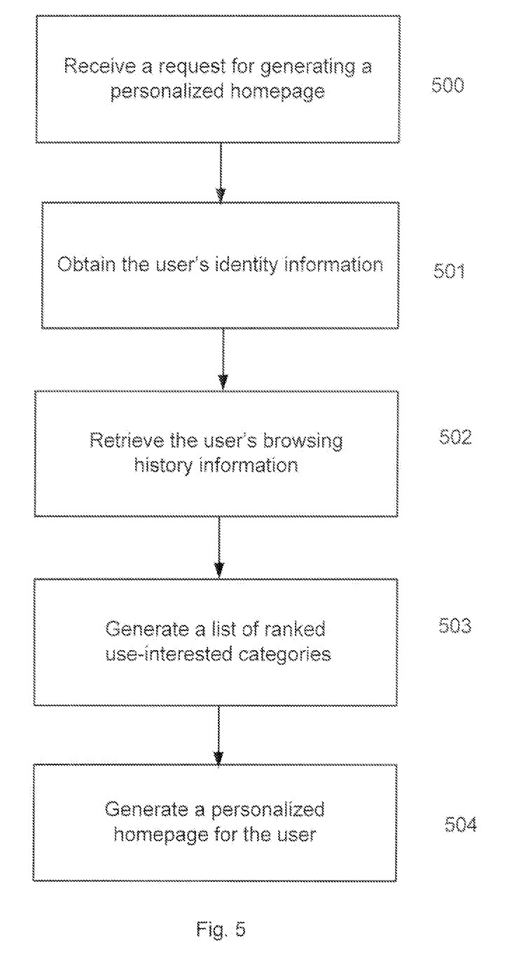

FIG. 5 is a flow chart of a method of creating a personalized homepage according to an embodiment of the present invention.

At 500, the server 201 may receive a request for initiating a personalized homepage. In one embodiment, the server 201 may regard the user's input of login information as the request.

At 501, a user's identity information may be obtained. In one embodiment, the server 201 may identify the user as John Smith by his login information, it should be understood that the server may identify the user by other type of information, e.g., an IP address or a browser cookie, or by information complied by a toolbar in the user's browser.

At 502, using the identity information, the server 201 may retrieve the user's browsing history information from the database 204. In FIG. 4, the user John Smith has 11 records in the database 204, and the server 201 may pull out all the category and sub-category information.

At 503, the server 201 may perform an algorithm to generate a list of ranked user categories. The algorithm may involve at least one interest criterion. In one embodiment, the interest criterion is the total times that a category has appeared in the record of the user in the database 204. As shown in FIG. 4, the user John Smith has visited properties in categories News, Weather, Stock Market Information, TV and Movies 5, 4, 3, 1 and 0 time(s) respectively. Accordingly, for the user John Smith, the category News may be assigned the highest rank, and the category Movies may be assigned the lowest rank. In another embodiment, the interest criterion may be the frequency at which properties in a category have been visited. For example, if during one day, the user John Smith visited properties in the category Weather 1 time, but visited properties in the category Stock Market Information 3 times, the category Stock Market Information may be assigned a higher rank, although the category Weather has a higher number of total visits in the user's record. It should be understood that other type of interest criteria may be used.

In one embodiment, the algorithm may include a predetermined number of categories which may be placed on a personalized homepage. If the number of a user's categories of interest is greater than the predetermined number, the list of ranked user categories may only include top ranked categories. For example, a user's browsing history information involves twelve categories. When the predetermined number is 10, the lowest ranked two categories may not be included in the ranked user-interested category.

In one embodiment, the algorithm may also rank sub-categories in a category in the list of ranked user-interested categories. In the embodiment shown in FIG. 4, the user John Smith visited the sub-category Basketball in the category Sports 2 times, more than any other sub-categories in that category. Accordingly, the sub-category may be assigned a higher rank.

At 504, according to the ranked user categories, a user's personalized homepage may be automatically generated, with modules related to a number of categories/sub-categories placed thereon. As shown in FIG. 4, the user John Smith's categories of interest include News, Weather, Stock Market Information and TV, so these categories may be shown on John's personalized homepage. Since John has never visited any properties in the category Movies and the category Movies is not in his category list, the category Movies will not be shown on his personalized homepage. Since John's category list also includes a number of sub-categories in the category News, these sub-categories may be shown on John's personalized homepage as well.

The personalized homepage may have one or more columns, and each column may be used to show one or more categories. In one embodiment, the categories are placed according to their ranks in the list of ranked user-interested categories, so that the category with the highest rank is placed at the most prominent location on the homepage, e.g., the upper left portion of the homepage. In another embodiment, the categories are placed for better presentation. In the embodiment shown in FIG. 4, since the user is interested in a number of sub-categories in the category News, a whole column may be used to show the category News, while another column is used to show all other categories. When a homepage has a wide column and a narrow column, categories looking better in a wide column may be placed in the wide column, and categories looking better in a narrow column may be placed in the narrow column.

Each category and sub-category may be populated with a number of modules or properties.

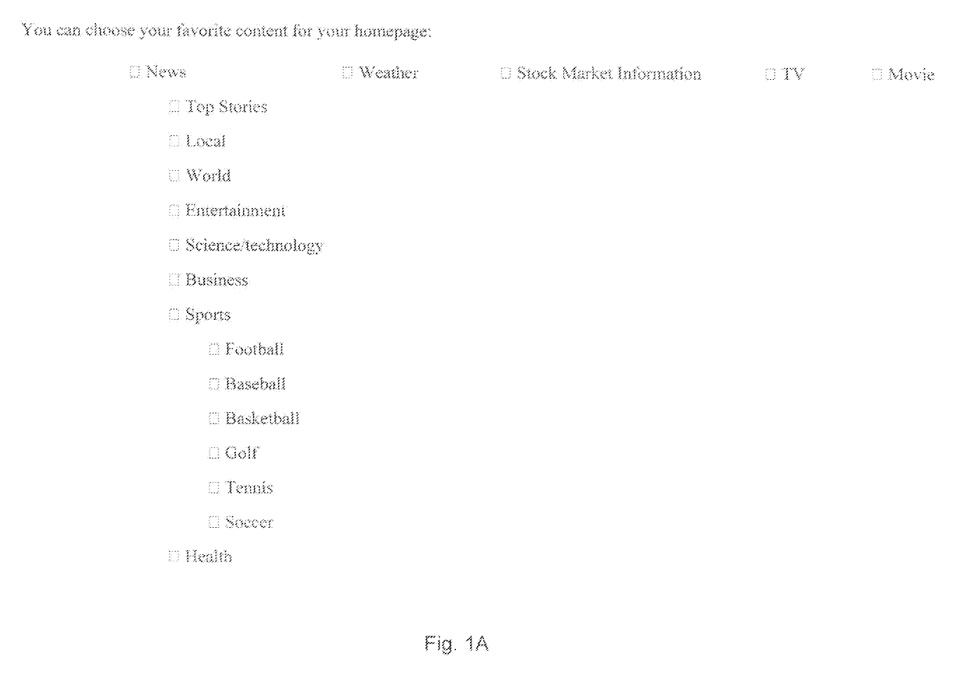

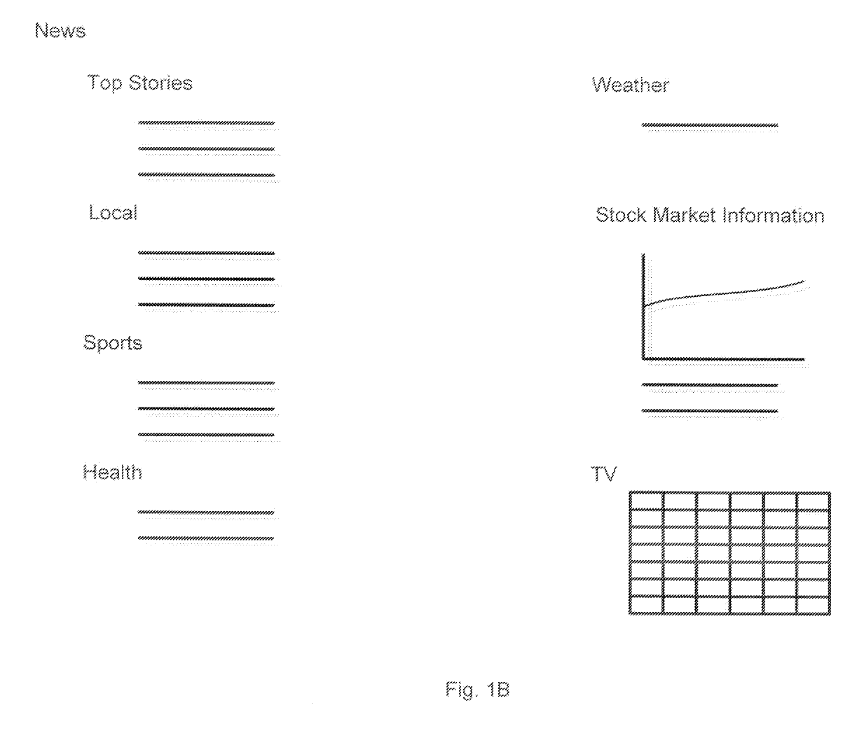

Thus, the method of the present invention may infer the user John Smith's interests before John expressly reveals such information, and generate a personalized homepage similar to that shown in FIG. 1B for John without asking him to spend time on selecting his interested categories.

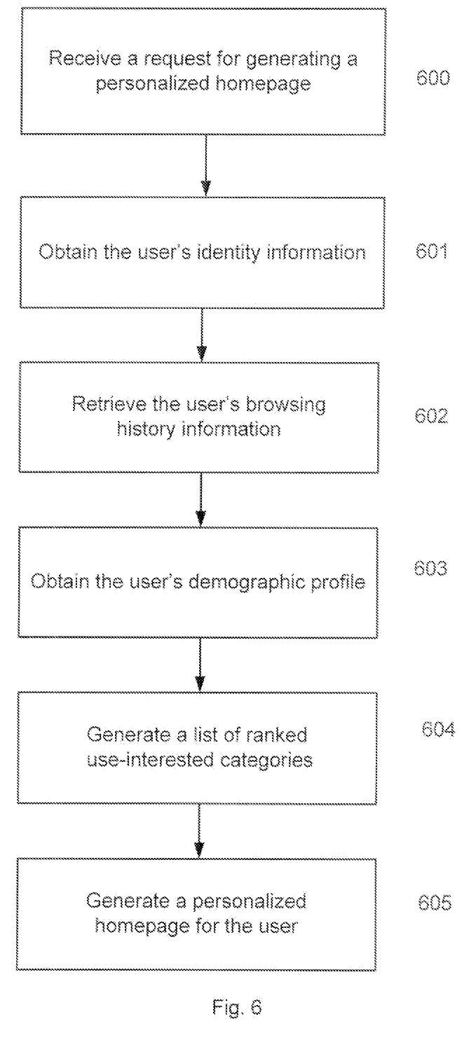

FIG. 6 is a flow chart of a method of creating a personalized homepage according to an embodiment of the present invention.

Similar to the embodiment shown in FIG. 5, a request for initiating a personalized homepage may be received at 600, a user's identity information may be obtained at 601, and the user's browsing history information may be obtained at 602.

At 603, based on the users identity information, the server 201 may obtain the user's demographic profile, which may include information such as the user's age and/or gender. In one embodiment, the user may provide his/her demographic information when signing up for a different but related web service product like an email account or an BBS account. Such demographic information is saved in a database and the server 201 is granted access to that database. It should be understood that 603 may be performed before 602 or at the same time as 602.

At 604, the server 201 may perform an algorithm to generate a list of ranked user categories of interest. The algorithm may involve at least one interest criterion, and the demographic information may be used to adjust the at least one interest criterion. In one embodiment, for a user under 20 years old, the criterion may be adjusted to increase the rank of the sub-category Sports, but lower the rank of the category Stock Market Information.

The demographic information may be used to adjust the rank of different modules in a category or sub-category. In one embodiment, for a female user, interest criterion for the sub-category Health may be adjusted to increase the rank of modules about women's health, while for a male user, the interest criterion may be adjusted to increase the rank of modules about men's health. In another embodiment, for users under 30 years old, the criterion for the category Stock Market Information may be adjusted to increase the rank of modules about long term investments, while for users over 60 years old, the criterion may be adjusted to increase the rank of modules about short term gains. Accordingly, the contents on the homepage may be more targeted at the user.

At 605, a personalized homepage may be generated, so that the categories, sub-categories and/or modules may be placed thereon according to their adjusted ranks, and at least one module is placed under each category/sub-categories.

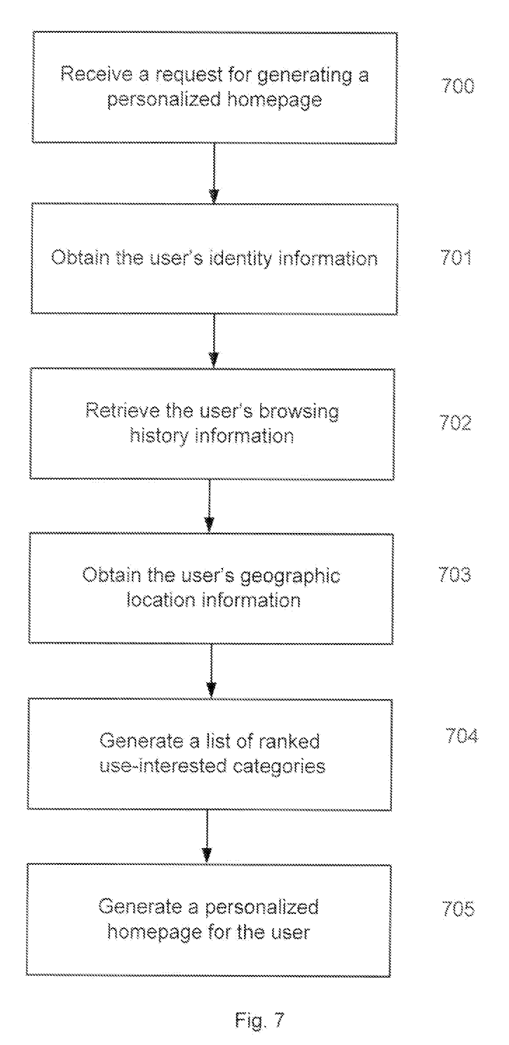

FIG. 7 is a flow chart of a method of creating a personalized homepage according to an embodiment of the present invention.

Similar to the embodiment shown in FIG. 5, a request for initiating a personalized homepage may be received at 700, a user's identity information may be obtained at 701, and the user's browsing history information may be obtained at 702.

At 703, the server 201 may obtain the user's geographic location. In one embodiment, the user's geographic location may be inferred from the user's IP address. In another embodiment, the user's location may be inferred from information the user input in a different but related web service product e.g., the groups the user joined at groups.yahoo.com. In a further embodiment, the user's geographic location may be input by the user. It should be understood that 703 may be performed before 702 or at the same time as 702.

At 704, the server 201 may perform an algorithm to generate a list of ranked user-interested categories, and the user's location may be used to adjust at least one interest criterion in the algorithm. In one example, it may be determined at 703 that the user is in San Antonio, Tex. Accordingly, the criterion for the category Weather may be adjusted to focus on weather information about that area. The interest criterion for the sub-category Local may be adjusted to focus on news related to San Antonio as well.

In one embodiment, the location information may be used to adjust the rank of different modules in a category or sub-category. For example, if the user is in San Antonio, Tex. and is interested in the sub-category Basketball, the interest criterion for that sub-category will be adjusted to increase the rank of modules about the San Antonio Spurs.

At 705, a personalized homepage may be automatically created according to the adjusted categories of interest, sub-categories and modules.

Although each of the embodiments described above personalizes contents of a homepage via adjusting an interest criterion in an algorithm, it should be understood that the personalization could be accomplished by adjusting other elements in the algorithm.

To protect the users' privacy, the method of the present invention does not expose users' browsing history. Instead, it learns a users browsing history in the background, infers the user's areas of interest, and places modules related to the areas of interest on a personalized homepage automatically created for the user.

In one embodiment, the user may have opportunities to adjust contents on the automatically generated personal homepage; to remove a category or sub-category in which he/she is not interested, and add one in which he/she is interested.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method comprising:
responsive to a request for initiating a first web service product, detecting user identity information associated with the request;
retrieving at least one of browsing history information, demographic information, or geographic location information associated with the user identity information and obtained during execution of a second web service product;
creating a list of categories of interest for the user according to the at least one of browsing history information, demographic information, or geographic location information; and
generating a personalized homepage for the user at the first web service product, wherein the personalized homepage comprises at least one module belonging to at least one category in the list of categories of interest.

2. The method of claim 1, wherein said detecting comprises checking login information.

3. The method of claim 1, wherein said retrieving comprises retrieving the browsing history information.

4. The method of claim 3, wherein the browsing history information comprises a category of a visited property.

5. The method of claim 3, wherein the browsing history information comprises a sub-category of a visited property.

6. The method of claim 1, wherein said retrieving comprises retrieving the browsing history information and at least one of the demographic information or the geographic location information.

7. The method of claim 1, wherein said creating comprises determining a rank of a category in the list of categories of interest.

8. The method of claim 7, further comprising placing categories on the personalized homepage according to their ranks.

9. The method of claim 1, wherein said creating comprises determining a rank of a sub-category in the list of categories of interest.

10. The method of claim 9, further comprising placing sub-categories on the personalized homepage according to their ranks.

11. The method of claim 6, further comprising adjusting contents of the personalized homepage based on demographic information of the user.

12. The method of claim 6, further comprising adjusting contents of the personalized homepage based on geographic location of the user.

13. A computer program having instructions for performing the method of claim 1.

14. A system for generating a personalized homepage at a first web service product, comprising:
a database of categories of interest storing at least one of browsing history information, demographic information, or geographic location information of at least one user obtained during execution of a second web service product; and
a processing unit, which
responsive to a request for initiating the first web service product, detects user identity information associated with the request;
retrieves the at least one of browsing history information, demographic information, or geographic information associated with the user identity information from the database of categories of interest;
creating a list of categories of interest for the user according to the at least one of browsing history information, demographic information, or geographic location information; and
generating a personalized homepage for the user at the first web service product, wherein the personalized homepage comprises at least one module for at least one category in the list of categories of interest.

15. The system of claim 14, wherein the processing unit detects the user identity information by checking login information.

16. The system of claim 14, wherein the processing unit retrieves the browsing history information.

17. The system of claim 16, wherein the browsing history information comprises a category of a visited property.

18. The system of claim 16, wherein the browsing history information comprises a sub-category of a visited property.

19. The system of claim 14, wherein the database stores the browsing history information and at least one of the demographic information or the geographic location information, and the processing unit retrieves the browsing history information and at least one of the demographic information or the geographic location information.

20. The system of claim 14, wherein the processing unit determines a rank of a category in the list of categories of interest.

21. The system of claim 20, wherein the processing unit further places categories on the personalized homepage according to their ranks.

22. The system of claim 14, wherein the processing unit determines a rank of a sub-category in the list of categories of interest.

23. The system of claim 22, wherein the processing unit places sub-categories on the personalized homepage according to their ranks.

24. The system of claim 19, wherein the processing unit further adjusts contents of the personalized homepage based on demographic information of the user.

25. The system of claim 19, wherein the processing unit further adjusts contents of the personalized homepage based on geographic location of the user.
